(19) United States
(12) Patent Application Publication
(10) Pub. No.: US 2017/0104217 A1
(43) Pub. Date: Apr. 13, 2017

(54) MATERIAL FOR USE IN A BATTERY, A BATTERY AND A METHOD OF MANUFACTURING A MATERIAL FOR USE IN A BATTERY

(71) Applicant: City University of Hong Kong, Kowloon (HK)

(72) Inventors: Yau Wai Denis YU, Mid-Levels (HK); Yingshun LI, Sheung Shui (HK)

(21) Appl. No.: 14/877,089

(22) Filed: Oct. 7, 2015

(51) Int. Cl. H01M 4/62; H01M 4/48; H01M 4/525; H01M 4/04; H01M 4/58; H01M 10/0525; H01M 10/054; H01M 10/052; H01M 4/38; H01M 4/505

(52) U.S. Cl. CPC H01M 4/628; H01M 4/382; H01M 4/381; H01M 4/387; H01M 4/386; H01M 4/48; H01M 4/525; H01M 4/505; H01M 4/5815; H01M 10/0525; H01M 10/054; H01M 10/052; H01M 4/0404; H01M 4/0471; H01M 2220/20; H01M 2220/30

(57) ABSTRACT

A material for use in a battery includes an active material arranged to undergo chemical reaction during charging and/or discharging of the battery, and a coating material coated on the active material, wherein the coating material is arranged to prevent the active material from cracking during charging and/or discharging of the battery.

### TECHNICAL FIELD

The present invention relates to a material for use in a battery, although not exclusively, to an anode material having a stretchable polymer coating thereon for battery applications.

### BACKGROUND

Batteries may be used in various portable or cordless devices or apparatus such as watches, mobile phones, power tools and even vehicles for providing source of energy for powering up these devices or apparatus. Depends on the types and amount of material used to build the batteries, these batteries may have different capacities for different applications.

In general, batteries may consist of an anode electrode and a cathode electrode. Whereupon chemicals in the electrode materials react, electrical current may be generated for driving an external electrical/electronic component in a device. In a rechargeable battery, the electrode materials are capable of repeatedly storing and releasing stored energy by means of reversible chemical reaction, and the electrodes may be designed to be repeatedly charged and discharged during the life cycle of the rechargeable battery, and the lifetime of the battery comes to an end when the electrode materials are no longer capable of being charged and/or discharged.

### SUMMARY OF THE INVENTION

In accordance with a first aspect of the present invention, there is provided a material for use in a battery comprising: an active material arranged to undergo chemical reaction during charging and/or discharging of the battery; and a coating material coated on the active material; wherein the coating material is arranged to prevent the active material from cracking during charging and/or discharging of the battery.

In an embodiment of the first aspect, the coating material is arranged to prevent the active material from cracking due to a volume change during charging and/or discharging of the battery.

In an embodiment of the first aspect, the volume change includes an expansion and/or a contraction of a volume of the active material.

In an embodiment of the first aspect, the expansion is caused by an insertion of an alkali metal to the active material and the contraction is caused by a removal of the alkali metal from the active material.

In an embodiment of the first aspect, the alkali metal includes lithium and/or sodium.

In an embodiment of the first aspect, the coating material is arranged to bind a plurality of portions of the active material.

In an embodiment of the first aspect, each of the plurality of portions of the active material comprises a cluster of active material.

In an embodiment of the first aspect, the coating material is further arranged to retain a binding between each of the plurality of portions of the active material during charging and/or discharging of the battery.

In an embodiment of the first aspect, the coating material is stretchable.

In an embodiment of the first aspect, the coating material consists of a polymer.

In an embodiment of the first aspect, the polymer includes at least one of polyimide, polyamide and polyimide-amide.

In an embodiment of the first aspect, the active material includes at least one of an element, a metal oxide, and a metal sulfide.

In an embodiment of the first aspect, the element includes at least one of Sn, Si, Ge, Al, Pb, P, Sb, Ga, Bi, In and Zn.

In an embodiment of the first aspect, the metal oxide includes at least one of SnO, SnO₂, Sb₂O₃, MnO, Co₃O₄, Fe₂O₃, NiO and ZnO.

In an embodiment of the first aspect, the metal sulfide includes at least one of SnS, SnS₂, Sb₂S₃, CoS, FeS and NiS.

In an embodiment of the first aspect, a combination of the active material and the coating material consists of 2% to 60% of coating material by weight.

In an embodiment of the first aspect, the active material is an anode material in the battery.

In accordance with a second aspect of the present invention, there is provided a battery comprising a material in accordance with the first aspect.

In an embodiment of the second aspect, the battery is a lithium-ion battery, a sodium-ion battery, a magnesium-ion battery or lithium-sulfur battery.

In accordance with a third aspect of the present invention, there is provided a method of manufacturing a material for use in a battery comprising the steps of coating an active material with a coating material, wherein the active material is arranged to undergo chemical reaction during charging and/or discharging of the battery and wherein the coating material is arranged to prevent the active material from cracking during charging and/or discharging of the battery.

In an embodiment of the third aspect, the coating material consists of a stretchable polymer.

In an embodiment of the third aspect, the method of manufacturing a material for use in a battery further comprises the step of curing a plurality of monomers to form the coating material.

In an embodiment of the third aspect, the method of manufacturing a material for use in a battery further comprises the step of mixing the plurality of monomers with the active material.

In an embodiment of the third aspect, the plurality of monomers includes imide monomer and/or amide monomer.

In an embodiment of the third aspect, the method of manufacturing a material for use in a battery further comprises the step of annealing a mixture of the plurality of monomers with the active material in inert ambient including at least one of nitrogen and argon.

In an embodiment of the third aspect, the mixture is annealed at a temperature between 150° C. and 550° C.

In an embodiment of the third aspect, the method of manufacturing a material for use in a battery further comprises the steps of transforming the annealed mixture to a slurry and depositing the slurry to a current collector to from an anode for use in a battery.

### BRIEF DESCRIPTION OF THE DRAWINGS

Embodiments of the present invention will now be described, by way of example, with reference to the accompanying drawings in which:

FIG. 1 is an illustration of a material for use in a battery in accordance with one embodiment of the present invention;

FIG. 2 is an illustration of the expansion and contraction of the material of FIG. 1;

FIG. 3 is an illustration of the expansion and contraction of a conventional material for use in a battery;

FIG. 4 is a plot showing a theoretical volume change of different materials for use in a battery with lithiation;

FIG. 5 is a plot showing a thermogravimetric analysis of a SnO₂ material mixed with a monomer/polymer;

FIG. 6A is a plot showing the capacity of a battery having an anode material of FIG. 1 with different mixing ratio of the active material and the coating material, wherein the anode material is annealed at 300° C.;

FIG. 6B is a plot showing the capacity of a battery having an anode material of FIG. 1 with different mixing ratio of the active material and the coating material, wherein the anode material is annealed at 450° C.; and

FIG. 7 is a plot showing the capacity of a battery having an anode material of FIG. 1 annealed at different temperature.

### DETAILED DESCRIPTION OF THE PREFERRED EMBODIMENT

The inventors have, through their own research, trials and experiments, devised that alloy and conversion-based materials has the ability to accommodate large amount of alkaline metal such as lithium or sodium, making them good choices for anode materials for battery applications.

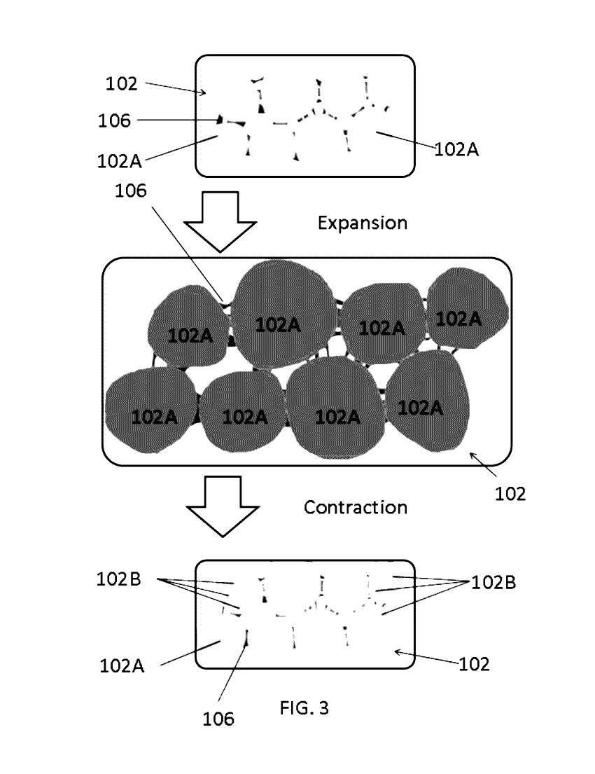

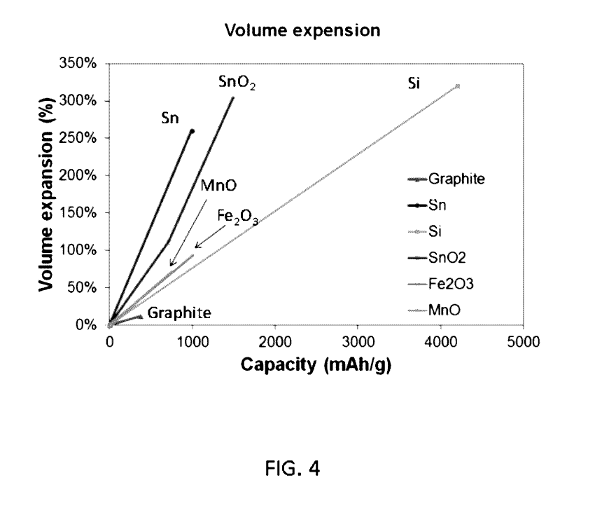

With reference to FIGS. 3 and 4, one of the drawbacks of these materials is the large volume change associated with lithium or sodium insertion and extraction, as well as the subsequent contraction of the volume due to the detachment of the inserted metal from the expanded materials. This may lead to material cracking, detachment of materials, delamination of the electrode, loss of element etc. which in turn decreases the capacity of the material and lead to poor cycle performance.

Nanostructuring may be adopted to incorporate spaces between the particles to accommodate the volume expansion of the active material during charge and discharge. However, mass production of nano-material is difficult and expensive. In addition, the density of the electrode with nano-material is low, so volumetric energy density of the electrode material is also low.

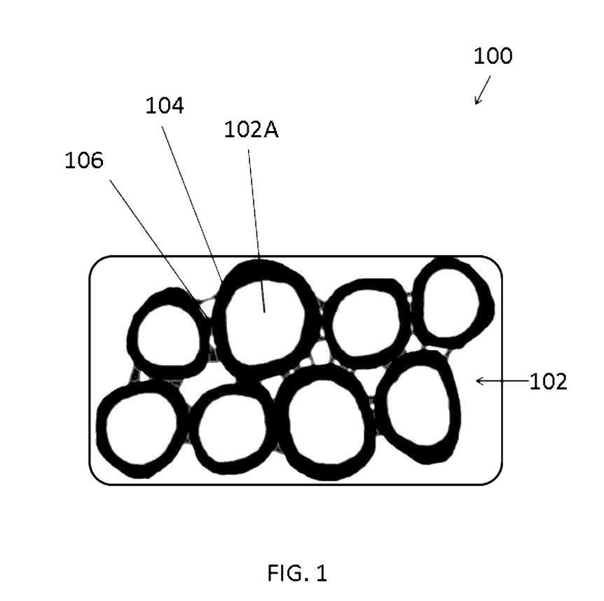

With reference to FIG. 1, there is shown an embodiment of a material 100 for use in a battery comprising: an active material 102 arranged to undergo chemical reaction during charging and/or discharging of the battery; and a coating material 104 coated on the active material 102; wherein the coating material 104 is arranged to prevent the active material 102 from cracking during charging and/or discharging of the battery.

In this embodiment, the active material 102 is a material arranged to accommodate an amount of metal/metal ions so as to accumulate an amount (chemical) energy. For example, the active material 102 may be an alloy and/or a conversion-based material having a plurality of sites for receiving an amount of alkaline metal (ions) such as Li/Li⁺ and/or Na/Na⁺ particles/ions under a suitable chemical reaction between the active material 102 and the metal ions.

Without limited by the following examples, the active material 102 may include one or more elements such as C, Sn, Si, Ge, Al, Pb, P, Sb, Ga, Bi, In and Zn. These materials and the alkaline metal may undergo reaction to store or release energy (preferably electrical energy in a battery application). For example, silicon may react with lithium ions in accordance with the following chemical equation:

Si+4.4Li⁺+4.4e⁻⇄Li_{4.4}Si

During “charging” (with an external supply of electric current/electrons), lithium ions are attached to the vacant sites on silicon in the active material 102 forming a Si/Li alloy, therefore lithium is “inserted” to the active material 102. In contrast, lithium ions are detached from the Si/Li alloy during “discharging” when the material supplies electrons/electric current to a connected device. The lithium ions may be supplied in an electrolyte in contact with the active material 102.

Alternatively and without limited by the following examples, the active material 102 may include one or more metal oxides such as SnO, SnO₂, Sb₂O₂, MnO, Co₂O₄, Fe₂O₃, NiO and ZnO, and Zn. These materials and the alkaline metal may undergo reaction to store or release energy. For example, manganese oxide may react with lithium ions in accordance with the following chemical equation:

MnO+2Li⁺+2e⁻⇄Mn+Li₂O

During “charging”, lithium ions are attached to manganese oxide in the active material 102, and convert manganese oxide to form lithium oxide and manganese metal, therefore lithium is “inserted” to the active material 102. During “discharging”, lithium ions are extracted to the electrolyte and manganese metal is converted back to become manganese oxide.

Alternatively and without limited by the following examples, the active material 102 may include one or more metal sulfides such as SnS, SnS₂, Sb₂S₃, CoS, FeS and NiS. These materials may undergo the abovementioned alloy and/or conversion reaction during the charging or the discharging process. For example, tin sulfide may react with lithium ions to form Li/Sn alloy and lithium sulfide in accordance with the following chemical equation:

SnS+5.75Li⁺+5.75e⁻⇄Li_{3.75}Sn+Li₂S

Some materials also show similar reaction(s) with sodium. It is appreciated by a skilled person that the active materials, the inserted metals and the intermediate products should not be limited by the above examples, and any material capable of storing/releasing energy by undergoing the abovementioned chemical reactions may be implemented as active material 102 in the material 100 for use in a battery in accordance with an embodiment of the present invention. In addition, the active material 102 may consist of one or more of the abovementioned substances configured to undergo the alloy and/or conversion reactions in the examples.

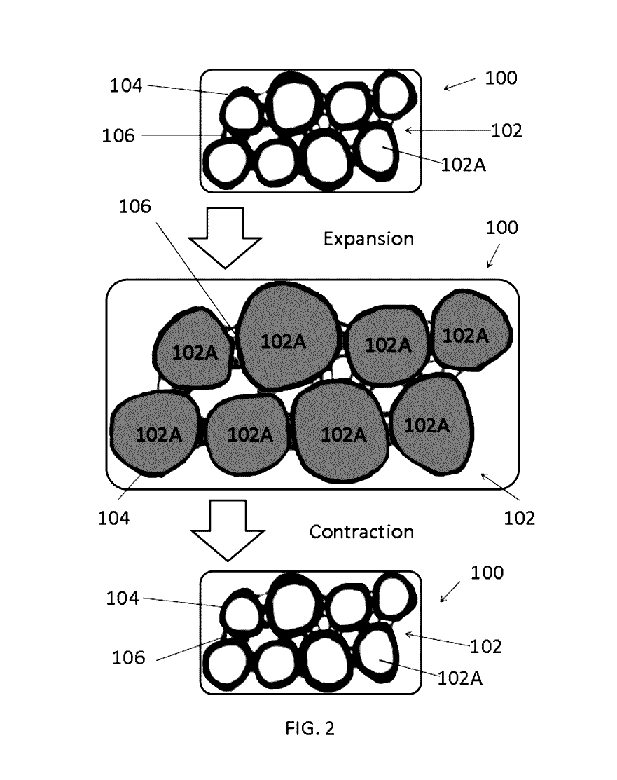

With reference to FIGS. 2 and 3, during these reactions, the volume of the active material 102 may expand during insertion of the alkali metal, and may contract when the alkali metal is removed as the material lattice must change to accommodate the extra atoms. Referring to FIG. 4, there is shown the theoretical volume change of some example materials vs. material capacity, based on crystal lattice size of the final reaction product.

For example, graphite in lithium-ion batteries may have a theoretical volume change of about 12%, though the capacity is only 372 mAh/g. Alternative anode materials, such as Si, Sn, SnO₂ may increase the capacity to >700 mAh/g, but the volume change is much bigger. For example, Li/Sn may have a capacity of 994 mAh/g, and the volume change may be of 260%. Li/Si may have a capacity of 4200 mAh/g, and the volume change may be as large as 320%. These large changes may lead to material cracking (as shown in FIG. 3) during the charge-discharge process, rendering portion(s) of the material inaccessible for further charge (and hence the subsequent discharge process). As a result, this may lead to low capacity with cycling.

In a battery structure, active material 102 may consist of electrodes having a layer of closely packed clusters or particles of the abovementioned examples materials. A plurality of individual clusters 102A may be further bound by a binder 106 between adjacent clusters 102A. The cracking of the material may be caused by the drastic decrease of volume of active material 102 from an originally charged and expanded form. During discharging of a battery (such as delithiation in a lithium-ion battery), especially during a rapid discharging process, an individual clusters 102A or particles may shrink and crack to form smaller clusters 102B. These smaller clusters 102B are not bound by a binder 106 or any material such that some of these smaller clusters 102B are inaccessible during the future charging/discharging cycles due to the loss on contact of these smaller clusters 102B to healthy portions/clusters 102A of the active material 102 and hence to the current/electron collector of the electrode. Therefore the battery capacity become lower and lower with charging/discharging cycling.

With reference back to FIGS. 1 and 2, the material 100 further comprises a coating material 104 coated on the active material 102. The coating material 104 is preferably a stretchable material such as a polymer and the coating material 104 may encapsulate or surround a certain volume of active material 102 as shown in the Figures. Since the coating material 104 is stretchable, the internal volume surrounded by the coating material 104 may expand and/or contract within a certain range.

Preferably, the coating material 104 may have a resilient physical property such that the coating material 104 may be at least partially deformed in different shapes and/or dimensions. For example, the coating material 104 may include a polymer consists of polyimide, polyamide, polyimide-amide or any other polymeric or resilient material as appreciated by a person skilled in the art. These example polymers are stretchable, and work like a balloon that surrounds the active material 102 and allows the active material 102 to expand without breaking apart, and arranged to exert a compressive force when the surrounded active material 102 shrinks such that the particles and/or clusters 102A of active material 102 are kept intact, and prevent the active material 102 from cracking (to form smaller clusters) due to a volume change during charging and/or discharging of the battery.

In addition, the coating material 104 may be arranged to serve as a binder 106 within the material, and hence to bind a plurality of individual portions 102A of the active material 102, each portion may consist of a cluster of active material 102 such as a group of particles of active with or without additional substances (such as carbon black which may be added to an electrode of a battery with the active material 102). The coating material 104 serving as a binder 106 is further arranged to retain a linkage between each of the plurality of portions (clusters) 102A of the active material 102 during expansion and/or contraction of the (individual portions of the) active material 102, i.e. during the charging and/or discharging of the battery. Alternatively or optionally, a plurality of the coated portions 102A of active material 102 may be bound by additional binder 106s.

The coating material 104 is electrically or electrochemically inactive. Therefore the higher the content of the coating material 104 in the material, the lower the specific (energy) capacity of the active material 102. On the other hand, material without coating material 104 shows poor cycle performances, so a minimum amount of polymer coating 104 is needed to contain the volume expansion of the particles. To maintain balance between good cycle performance and high capacity, the amount of monomer precursor used is preferably between 2 wt % and 60 wt %, with respect to the mass of the active material 102, such that the combination of the active material 102 and the coating material 104 consists of 2% to 60% of coating material 104 by weight.

These embodiments of material may be used in a battery such as but not limited to a lithium-ion battery, a sodium-ion battery, a magnesium-ion battery or lithium-sulfur battery. Preferably, the active material is used as an anode material which is arranged form an anode electrode in the battery.

In accordance with an embodiment of the present invention, there is provided a method of manufacturing a material 100 for use in a battery comprising the steps of coating an active material 102 with a coating material 104, wherein the active material 102 is arranged to undergo chemical reaction during charging and/or discharging of the battery and wherein the coating material 104 is arranged to prevent the active material 102 from cracking during charging and/or discharging of the battery.

In this embodiment, the coating material 104 consists of a stretchable polymer discuss earlier, which may consist of at least one of polyimide, polyamide and polyimide-amide. These polymers may be formed by curing a plurality of monomers to form the required coating material 104. Example of monomers used may include imide monomers and/or amide monomers.

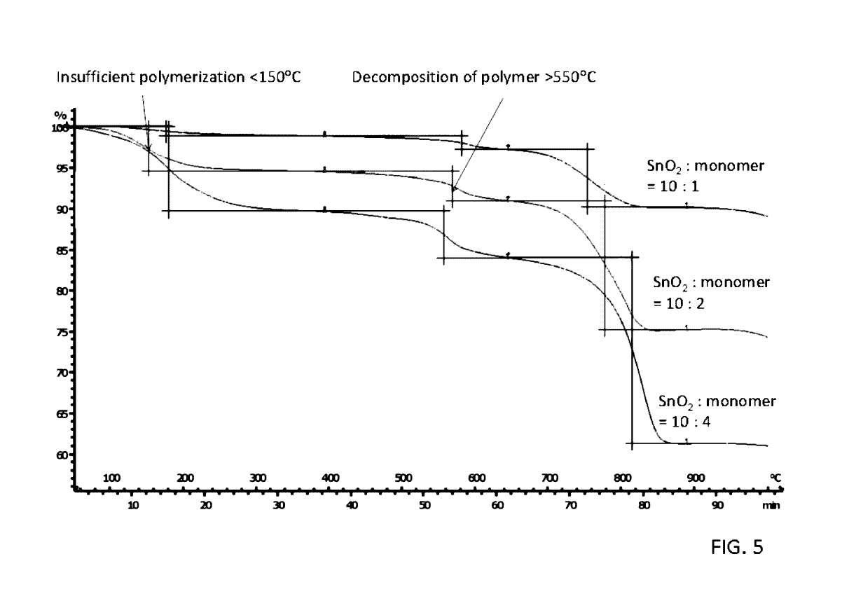

With reference to FIG. 5, a thermogravimetric analysis of a SnO₂ material mixed with a monomer/polymer is shown. In this analysis, mixtures of SnO₂ material and a monomer with different mixing ratios (10:1, 10:2 and 10:4) were annealed to examine the polymerization process of the monomer. It is observed from the Figure that the polymerization of the monomers is insufficient or inefficient below about 150° C. and the cured polymer may decompose at a temperature higher than about 550° C.

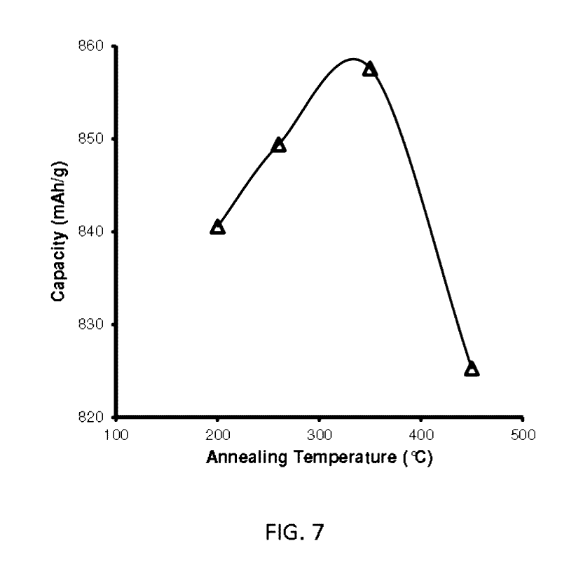

Therefore to cure the monomers to form a polymer coating 104, the monomers may be annealed in a high temperature, preferably between 150° C. and 550° C., In addition, the polymerization or the annealing process of the monomers may be carried out in inert ambient including at least one of nitrogen and argon. The process parameters for the annealing process may affect the polymerization of the monomers and hence the properties of the cured polymer 104 and the electrical and/or electrochemical properties of the anode material 100. For example, with reference to FIG. 7, different capacities of a fabricated battery may be obtained in which the anode material 100 contains polymer 104 annealed in different temperatures.

To evenly distribute the polymer coating between individual portions of the active material 102, in an example embodiment, the plurality of monomers are mixed with the active material 102 which may be in form of powders/clusters/particles. The mixture of the monomers and the active material 102 may be annealed together such that polymer 104 is formed between individual portions 102A so as to surround these individual portions 102A and at the same time may bind these individual portions of active material 102. Finally, the annealed mixture may be transformed to a slurry by mixing with other fillings such as carbon black and binder, and the slurry may be further deposited to a current collector to form an electrode such as an anode for use in a battery.

These embodiments may be advantageous in that, the stretchable coating works like a balloon that surrounds the material, allowing the active material to expand with lithium or sodium insertion without breaking apart, at the same time exerting a compressive force during lithium or sodium removal to keep the particles intact. This enables reversible cycling of the material and improves cycle performance of an electrode.

Advantageously, stretchable coating according to these embodiments may be applied to anode materials for battery applications such as lithium-ion and sodium-ion batteries. The active material with the coating will be able to capture and release lithium and/or sodium ions reversibility without structural and mechanical damage.

The coating material may be easily introduced to the material, thus these embodiments are favourable for mass production. It only requires an additional coating step of commercially available materials. There is no need to special change the battery production process so as to improve the performance of the battery.

In an example embodiment, a method of manufacturing a battery with the material 100 having the active material 102 and the coating material 104 is provided. In this example, SnO₂ is mixed with 13, 26 and 53 wt % of imide monomers (3,3′,4,4′-benzophenonetetracarboxylic dianhydride BTDA and m-Phenylenediamine M-PDA) with NMP as a solvent. The mixture is dried, and then annealed to 300° C. for 4 hours in nitrogen flow. Afterwards, the materials are mixed with acetylene black and carboxymethyl cellulose in a weight ratio of 6:2:2 with water into a slurry. The slurry is then coated on a copper current collector and dried at 80° C. The electrodes were then cut into 16 mm diameter discs and pressed by a roll press. The electrodes were further dried at 110° C. for 4 hours in vacuum before putting in a glove box. The electrodes were assembled into a 2032 coin cell with Li counter electrode and 1 M LiPF₆ in fluoroethylene carbonate (FEC) to diethyl carbonate (DEC) of 1:1 ratio.

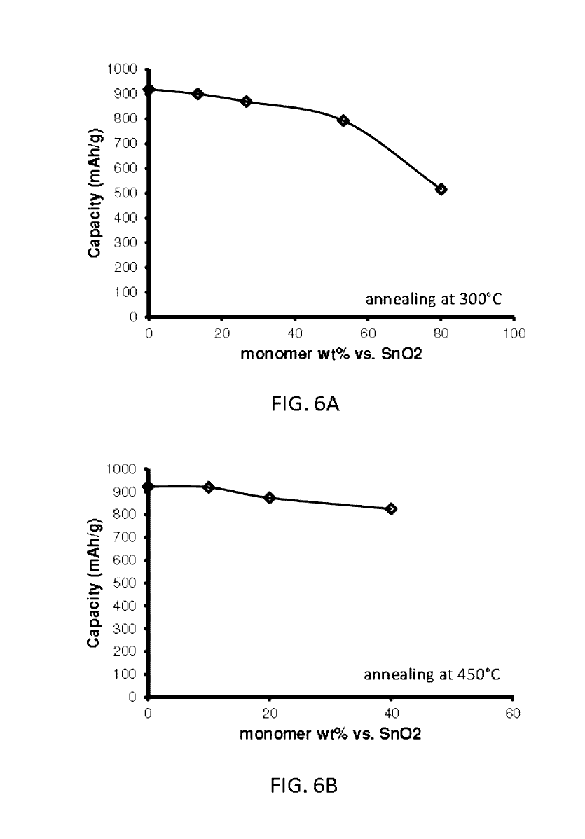

The cells were tested initial for 5 cycles at 100 mA/g between 0 and 2.5V vs. Li/Li+. Afterwards, they were cycled at a current of 250 mA/g for 100 cycles. Cycle performance (capacity retention) is defined as the ratio of charge capacity on the 50^{th} cycle to that on the 6^{th} cycle at a current of 250 mA/g. With reference to FIG. 6A, it is observed that the material shows a good balance between charge capacity and capacity retention when the polymer coating amount is between 2% and 60%.

Different amounts of coating material (including 0 wt % which refers to a material without coating material) were introduced to the active material in the tested batteries. The measurement results are shown in the table below. Although the material with 80 wt % polyimide gives a capacity retention of about 95.1%, but the charge capacity is 524.5 mAh/g. On the other hand, material without the coating material has a highest 2^{nd} charge capacity of 923.8 mAh/g, but the capacity retention is of about 86.7% after 50 cycles.

| | | | 2^{nd} charge | |
|---|---|---|---|---|
| | Amount of | Annealing | capacity at | Capacity retention |
| | polymer | temperature | 100 mA/g | (50^{th} capacity over |
| | coating | (° C.) | (mAh/g) | 6^{th} capacity) |
| Example 1a | 0 wt % | — | 923.8 | 86.7 |
| Example 1b | 13 wt % | 300 | 902.2 | 91.1 |
| Example 1c | 27 wt % | 300 | 857.4 | 93.6 |
| Example 1d | 53 wt % | 300 | 789.6 | 96.1 |
| Example 1e | 80 wt % | 300 | 524.5 | 95.1 |

With reference to FIG. 6B, similar batteries were fabricated with the annealing temperature of the polymerization process raised to 450° C. The results shows a similar trend of the performance of the batteries with different amounts of coating material introduced to the anode material when compared to the trend as shown in FIG. 6A.

In another example embodiment, SnO₂ is mixed with 40 wt % of imide monomers (BTDA/M-PDA) with NMP as a solvent. The mixture is dried, and then annealed to different temperatures for 4 hours in nitrogen flow. The materials were then made into tests cells similar to the previous example.

With reference to FIG. 7 and the table below, all four samples (Example 2a-2d) give capacity retention of close to 100% after 50 cycles. These results suggest that the processing window for producing the material is sufficiently high for industrial purpose and mass production.

| | | | 2^{nd} charge | |
|---|---|---|---|---|
| | Amount of | Annealing | capacity at | Capacity retention |
| | polymer | temperature | 100 mA/g | (50^{th} capacity over |
| | coating | (° C.) | (mAh/g) | 6^{th} capacity) |
| Example 2a | 40 wt % | 200 | 840.6 | 102.3 |
| Example 2b | 40 wt % | 260 | 849.4 | 99.7 |
| Example 2c | 40 wt % | 350 | 857.6 | 98.8 |
| Example 2d | 40 wt % | 450 | 825.3 | 101.2 |

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A material for use in a battery comprising:
an active material arranged to undergo chemical reaction during charging and/or discharging of the battery; and
a coating material coated on the active material; wherein the coating material is arranged to prevent the active material from cracking during charging and/or discharging of the battery.

2. A material in accordance with claim 1, wherein the coating material is arranged to prevent the active material from cracking due to a volume change during charging and/or discharging of the battery.

3. A material in accordance with claim 2, wherein the volume change includes an expansion and/or a contraction of a volume of the active material.

4. A material in accordance with claim 3, wherein the expansion is caused by an insertion of an alkali metal to the active material and the contraction is caused by a removal of the alkali metal from the active material.

5. A material in accordance with claim 4, wherein the alkali metal is selected from lithium and sodium.

6. A material in accordance with claim 1, wherein the coating material is arranged to bind a plurality of portions of the active material.

7. A material in accordance with claim 6, wherein each of the plurality of portions of the active material comprises a cluster of active material.

8. A material in accordance with claim 6, wherein the coating material is further arranged to retain a binding between each of the plurality of portions of the active material during charging and/or discharging of the battery.

9. A material in accordance with claim 1, wherein the coating material is stretchable.

10. A material in accordance with claim 1, wherein the coating material consists of a polymer.

11. A material in accordance with claim 10, wherein the polymer includes at least one of polyimide, polyamide and polyimide-amide.

12. A material in accordance with claim 1, wherein the active material includes at least one of an element, a metal oxide, and a metal sulfide.

13. A material in accordance with claim 12, wherein the element includes at least one of Sn, Si, Ge, Al, Pb, P, Sb, Ga, Bi, In and Zn.

14. A material in accordance with claim 12, wherein the metal oxide includes at least one of SnO, SnO₂, Sb₂O₃, MnO, Co₃O₄, Fe₂O₃, NiO and ZnO.

15. A material in accordance with claim 12, wherein the metal sulfide includes at least one of SnS, SnS₂, Sb₂S₃, CoS, FeS and NiS.

16. A material in accordance with claim 1, wherein a combination of the active material and the coating material consists of 2% to 60% of coating material by weight.

17. A material in accordance with claim 1, wherein the active material is an anode material in the battery.

18. A battery comprising a material in accordance with claim 1.

19. A battery in accordance with claim 18, wherein the battery is a lithium-ion battery, a sodium-ion battery, a magnesium-ion battery or lithium-sulfur battery.

20. A method of manufacturing a material for use in a battery comprising the steps of coating an active material with a coating material, wherein the active material is arranged to undergo chemical reaction during charging and/or discharging of the battery and wherein the coating material is arranged to prevent the active material from cracking during charging and/or discharging of the battery.

21. A method of manufacturing a material in accordance with claim 20, wherein the coating material consists of a stretchable polymer.

22. A method of manufacturing a material in accordance with claim 20, further comprising the step of curing a plurality of monomers to form the coating material.

23. A method of manufacturing a material in accordance with claim 22, further comprising the step of mixing the plurality of monomers with the active material.

24. A method of manufacturing a material in accordance with claim 23, wherein the plurality of monomers are selected from imide monomers and amide monomers.

25. A method of manufacturing a material in accordance with claim 23, further comprising the step of annealing a mixture of the plurality of monomers with the active material in inert ambient including at least one of nitrogen and argon.

26. A method of manufacturing a material in accordance with claim 25, wherein the mixture is annealed at a temperature between 150° C. and 550° C.

27. A method of manufacturing a material in accordance with claim 25, further comprising the steps of transforming the annealed mixture to a slurry and depositing the slurry to a current collector to from an anode for use in a battery.
